(19) United States
(12) Patent Application Publication
(10) Pub. No.: US 2005/0218173 A1
(43) Pub. Date: Oct. 6, 2005

(54) Line reel with cutting blade

(76) Inventor: Robert A. Hickey, Sun Prairie, WI (US)

Correspondence Address: JANSSON, SHUPE & MUNGER & ANTARAMIAN, LTD, 245 MAIN STREET, RACINE, WI, 53403, US

(21) Appl. No.: 10/818,026

(22) Filed: Apr. 5, 2004

(51) Int. Cl. B26F 3/02

(52) U.S. Cl. 225/56

(57) ABSTRACT

An improved line reel is disclosed having a fixed member with a handle, a rotatable member rotatably mounted to the fixed member, and at least one notch in one of the members with a blade embedded in the notch. Preferably, the blade is recessed within the notch and the notch is sized to block insertion by any finger of a user of the line reel.

### FIELD OF THE INVENTION

This invention is related generally to line reels and, more particularly, to line reels dispensing and storing construction line.

### BACKGROUND OF THE INVENTION

Line reels, also commonly known as line dispensers, have been used for years to dispense a variety of elongated materials such as string, code or rope. These devices are particularly useful to construction workers like carpenters or masons. Since straight lines are often needed to properly align structural elements during construction, these workers frequently call upon a line reel to dispense a length of heavy string that is pulled taut to create such a line. This heavy string is commonly known as construction line.

Line reels in the prior art typically have a handle or similar grip structure rotatably attached to a rotatable member. The rotatable member holds or stores in some manner construction line or other elongate material. Upon gripping the reel in one hand by the handle, the user can proceed to turn the rotatable portion in one direction to freely release a length of line and in the other direction to return the line back onto the reel. This process is repeated with each use whereby a certain portion of the line will be utilized over and over again. Moreover, this is done under a variety of weather and work conditions at the construction site. Over time, therefore, some length of the line will become worn, knotted, tangled or otherwise unusable. The user of the device is required then to cut off the damaged portion of the line from the remainder stored on the reel. This allows the line being dispensed by the reel is line that can establish a straight line in the most desirable fashion.

A problem with line reels is that it can be time-consuming and often inconvenient to require a user to search a crowded and disorganized work site for a utility knife or similar line cutter whenever the cutting of worn line is necessary. There is no convenient place to store such a line cutter whenever it is not being used since the line reel is typically needed at a variety of locations by a number of different workers throughout the construction site. As a result, the line cutter may often become misplaced or lost.

There is a significant need, therefore, for an improved line reel that provides access to a line cutter upon the reel itself. A device that accomplishes this and does so by conveniently locating the line cutter upon the line reel in a safe and inexpensive manner would be even more highly desirable. This invention meets these needs and overcomes other problems and shortcomings in the prior art.

### OBJECTS OF THE INVENTION

It is a primary object of this invention to provide an improved line reel that overcomes some of the problems and shortcomings of the prior art.

Another object of this invention is to provide an improved line reel that provides the user with an easily accessible blade with which to cut the elongate material stored on the line reel.

Another object of this invention is to provide a novel line reel having a blade recessed within a notch on the line reel that allows for save and reliable cutting of the elongate material being dispensed by the line reel.

Another object of this invention is to provide an exceptional line reel having a notch with an embedded blade at a location on the line reel that allows for convenient and accurate cutting of the construction line or other elongate material being used with the reel.

Another object of this invention is to provide an excellent line reel having a notch with an embedded blade to allow for more efficient use of the line reel through the elimination of the time needed to search and locate an external line cutter.

Another object of this invention is to provide an exceptional line reel that combines a line dispenser with a line cutter and yet is simple in structure, inexpensive to manufacture, and highly reliable to use.

### SUMMARY OF THE INVENTION

This invention is for an improvement to a line reel of the type for dispensing and storing elongate material. The improved line reel has a fixed member having a handle, a rotatable member rotatably mounted with respect to the fixed member, and at least one notch, preferably a single notch, in one of the members, the notch having a blade embedded within it. A line reel that can cut a length of the elongate material being dispensed and stored on the reel with a blade on the reel represents a clearly advantageous and novel advance to the art.

In one preferred embodiment of this invention, the rotatable member has a shaft and two end-members where one of the end-members defines the notch. It is most preferred that each end-member have an outer surface and that the notch be positioned along this outer surface. A highly preferred embodiment is where the blade is recessed below the outer surface.

A certain desired embodiment finds the shaft and end-members formed from polymeric materials. In some preferred forms, the notch is sized to block insertion into the notch of a finger of a user. It is highly desirable for reels in these forms that the blade be recessed within the notch.

### BRIEF DESCRIPTION OF THE DRAWINGS

FIG. 1 is a perspective view of a preferred line reel in accordance with this invention.

FIG. 2 is a front view of the line reel in FIG. 1.

FIG. 3 is a exploded view of the line reel in FIG. 1.

### DETAILED DESCRIPTION OF PREFERRED EMBODIMENTS

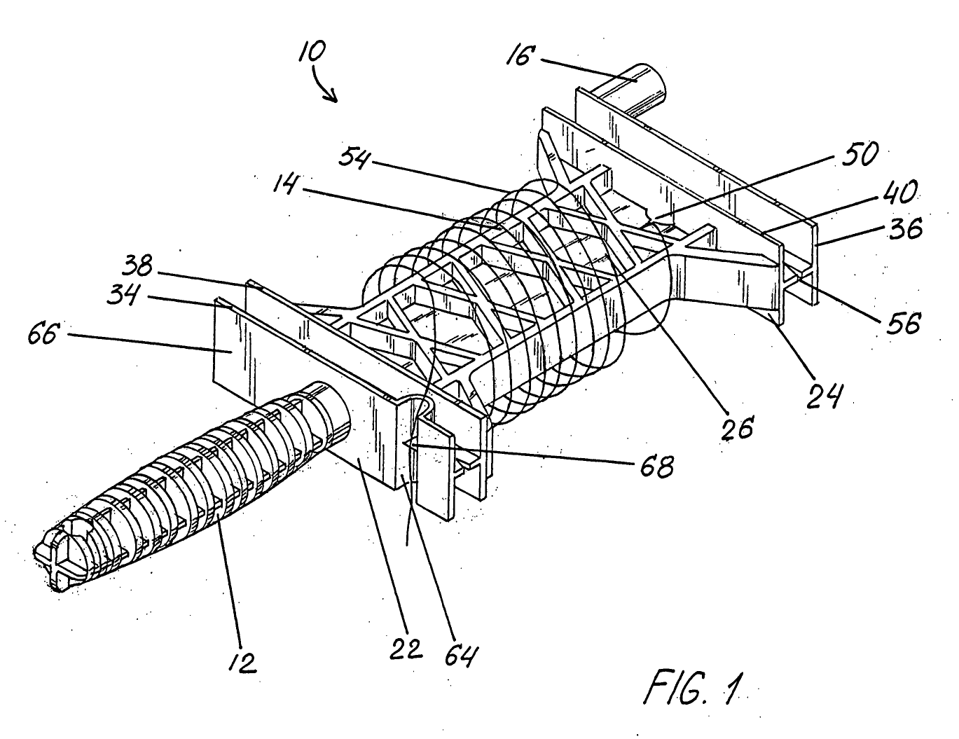

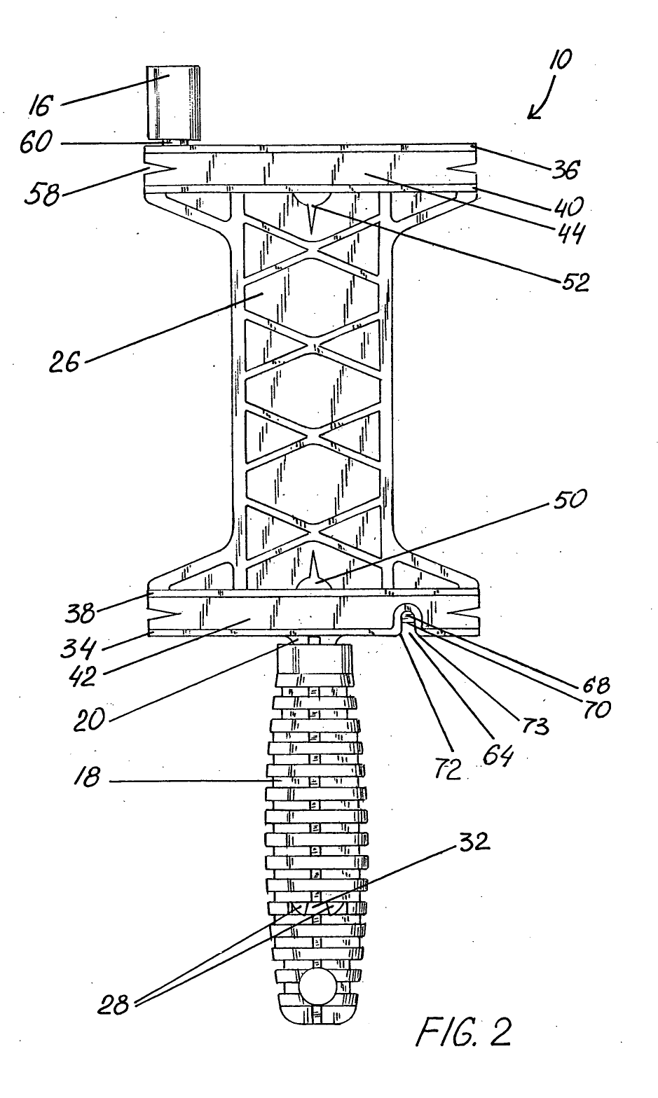

The drawings illustrate an improved line reel 10 in accordance with this invention. As illustrated in FIGS. 1-3, line reel 10 has a handle assembly 12, a reel frame 14, and a winding knob 16. Each of these members is preferably formed from polymeric materials.

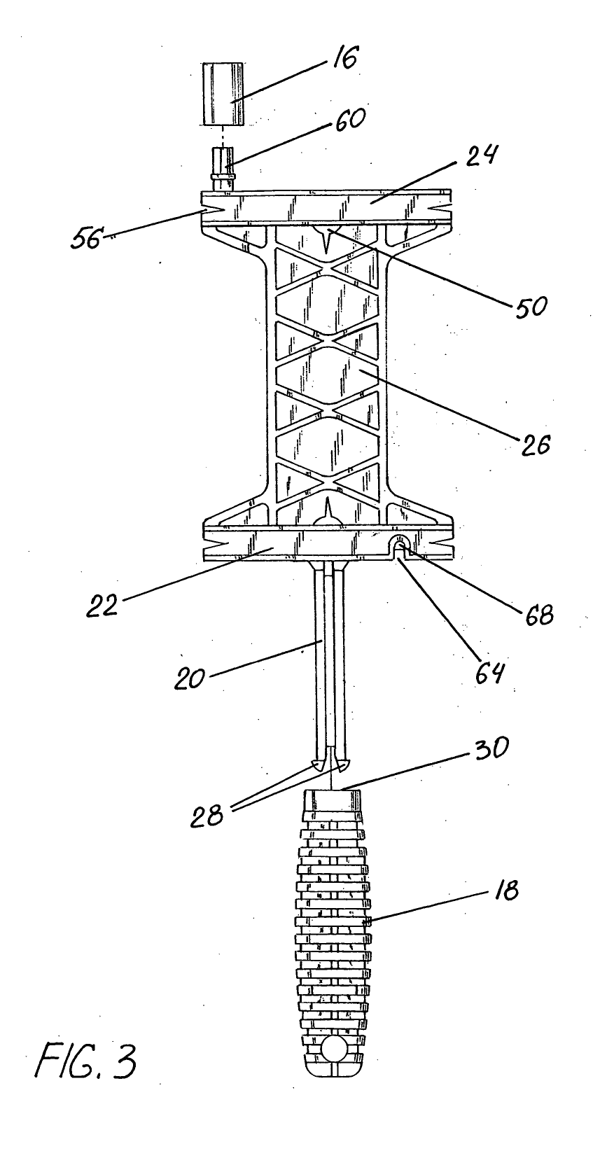

As shown in FIG. 3, handle assembly 12 includes handle 18 and handle-post 20. Reel frame 14 has first end-member 22 adjacent to handle-post 20, second end-member 24 adjacent to winding knob 16, and a shaft 26 extending between end-members 22, 24.

Handle-post 20 is rigidly attached to first end-member 22. As shown in FIG. 3, handle-post 20 is an elongate structure having a pair of coplanar lobes 28. Lobes 28 extend radially outward from the distal end of handle-post 20.

Handle 18 is an elongate member having a handle-opening 30 extending axially through the center of handle 18. Handle-opening 30 is sized to slidably receive handle-post 20 for mounting handle 18 rotatably on handle-post 20. Handle 18 is sometimes referred to herein as a “fixed member” of line reel 10 and reel frame 14, in combination with handle-post 20 and winding knob 16, is referred to as a “rotatable member.”

The distal end of handle-opening 30 opens into an annular handle-enclosure 32. Lobes 28 compress radially inward when handle-post 20 is slidably inserted into handle 18 to form handle assembly 12. Lobes 28 are biased to expand radially outward when the distal end of handle-post 20 enters handle-enclosure 32 to catchably engage the proximal surface of handle-enclosure 32. Handle-enclosure 32 and handle-opening 30 are sized to allow handle 18 to be mounted to handle-post 20 in a rotatable manner. It can be appreciated that handle-post 20 can be rotatably mounted to first end-member 22 and handle 18 then rigidly mounted to handle-post 20 in other embodiments of this present invention.

First and second end-members 22, 24 have an I-beam configuration. Each is provided with outer-wall 34, 36, inner-wall 38, 40, and connecting cross-member 42, 44. Cross-member 42, 44 is orthogonal to the corresponding inner-wall and outer-wall to which it is attached.

Shaft 26 is provided with two anchor-notches 50. Each anchor-notch is adjacent to an inner-wall 38, 40 along the axis of shaft 26. Anchor-notch 50 is formed from a V-shaped slit within shaft 26. The opening 52 to anchor-notch 50 is sized to receive the diameter of the elongate material being used on line reel 10. As shown in FIG. 1, the elongate material preferably used is construction line 54. Anchor-notch 50 has a narrowing width distal from its opening 52, whereby inserting one end of construction line 54 frictionally grips line 54 to shaft 26. After being anchored in this manner, line 54 is wound repeatedly around shaft 26 between end-members 22, 24 for later dispensing by a user of line reel 10.

Grip-notches 56 are preferably provided at each end of first and second cross-members 42, 44. It can be appreciated that fewer than four grip-notches 56 may be provided in other embodiments of the present invention. Each grip-notch 56 includes an grip-opening 58 sized to receive the diameter of line 54. Grip-notch 56 is a V-shaped structure having a narrowing width distal from grip-opening 58. Inserting line 54 laterally into grip-notch 56 with sufficient force secures line 54 frictionally therein. Grip-notch 56 may be used on line reel 10 to secure the loose end of line 54 when line reel 10 is not in use or to anchor one end of a length of line 54 when the line is being used to create a straight edge between two structural points at a construction site.

Second outer-wall 36 has a knob-post 60 rigidly secured at one end. Knob-post 60 is positioned on outer-wall 36 to be eccentric to the axis of handle 18. Winding knob 16 is rotatably mounted onto knob-post 60. Winding knob 16 can be gripped in one hand while handle 18 is grasped in the other to allow the user of line reel 10 to rotate shaft 26 about its axis for winding or unwinding construction line 54. It can be appreciated that knob-post 60 can be rotatably mounted to second outer-wall 36 and winding knob 16 then rigidly mounted to knob-post 60 in other embodiments of this present invention.

First outer-wall 34 defines a half-cylindrical cutting notch 64 orthogonal to outer-surface 66 of first outer-wall 34. A blade 68 is rigidly embedded within cutting notch 64. Top-edge 70 of blade 68 is recessed below outer-surface 66. Blade 68 is in a plane perpendicular to the plane of first outer-wall 34. The distance between opposite notch-edges 72, 73 along outer-surface 66 is sized to block insertion of any finger of a user into notch 64 but to permit construction line to be placed longitudinally within notch 64.

A desired length of construction line 54 can be easily and conveniently cut from the line 54 wound around line reel 10 by placing line 54 laterally into cutting notch 64 and then drawing line 54 downward across top-edge 70 with sufficient force at the desired point. Blade 68 is preferably constructed from stainless or carbonized steel. Although it is preferable to position cutting notch 64 along the outer-surface 66 of first outer-wall 34, cutting notch 64 can be placed at other locations on line reel 10 where it may be convenient to have a blade 68 for cutting line 54 in accordance with this invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A line reel of the type for dispensing and storing elongate material comprising:
a fixed member having a handle;
a rotatable member rotatably mounted with respect to the fixed member; and
at least one notch in one of the members having a blade embedded therein,
whereby a length of elongate material can be cut with the blade at the notch.

2. The line reel of claim 1 wherein the rotatable member has a shaft and two end-members, at least one end-member defining the notch.

3. The line reel of claim 2 wherein each end-member has an outer surface, the notch being positioned along the outer surface.

4. The line reel of claim 3 wherein the blade is recessed below the outer surface.

5. The line reel of claim 2 wherein the shaft and end-members are formed from polymeric materials.

6. The line reel of claim 1 wherein the blade is recessed within the notch.

7. The line reel of claim 6 wherein the notch is sized to block insertion into the notch of any finger of a user.
